(19) United States
(12) Patent Application Publication
(10) Pub. No.: US 2025/0270102 A1
(43) Pub. Date: Aug. 28, 2025

(54) AMMONIUM NITRATE PRODUCTION

(71) Applicants: KATHOLIEKE UNIVERSITEIT LEUVEN, Leuven (BE); UNIVERSITEIT ANTWERPEN, Antwerpen (BE)

(72) Inventors: Johan MARTENS, Sint-Joris-Weert (BE); Lander HOLLEVOET, Beerse (BE); Annemie BOGAERTS, Wilrijk (BE); Yury GORBANEV, Wilrijk (BE)

(21) Appl. No.: 18/701,078

(22) PCT Filed: Oct. 24, 2022
(86) PCT No.: PCT/EP2022/079611

§ 371 Date: Apr. 12, 2024

(30) Foreign Application Priority Data
Oct. 25, 2021 (EP) 21204454.9
Oct. 26, 2021 (EP) 21204782.3

(51) Int. Cl. C01C 1/18; C25B 1/04; C25B 15/08

(52) U.S. Cl. CPC C01C 1/185; C25B 1/04; C25B 15/081

(57) ABSTRACT

A process for the production of ammonium nitrate from water and a N2 and O2 including gas. The process relates to a system or method for electrified production of ammonium nitrate from air and water (for instance water comprised in the air). A certain aspect of the process is the use of ambient air surroundings in an apparatus to produce ammonium nitrate thereof.

### BACKGROUND AND SUMMARY

### Background of the Invention

### A. Field of the Invention

The present invention relates generally to a process for the production of ammonium nitrate from water and a N₂ and O₂ comprising gas. More particularly, it relates to a system or method for electrified production of ammonium nitrate from air and water (for instance water comprised in the air). A certain aspect of present invention is the use of ambient air surroundings in an apparatus of present invention to produce ammonium nitrate thereof.

Several documents are cited throughout the text of this specification. Each of the documents herein (including any manufacturer's specifications, instructions etc.) are hereby incorporated by reference; however, there is no admission that any document cited is indeed prior art of the present invention.

### B. Description of the Related Art

Ammonium nitrate is synthesized by reaction of ammonia with nitric acid. Ammonia is an industrial large-volume chemical, with the main application in fertilizer production, in particular ammonium nitrate. It also attracts increasing attention as a green-energy vector. Over the past century, ammonia production has been dominated by the Haber-Bosch process, in which a mixture of nitrogen and hydrogen gas is converted to ammonia at high temperatures and pressures. Haber-Bosch processes with natural gas or other fossil carbon source used for producing hydrogen gas are responsible for a significant share of the global CO₂ emissions. Furthermore, to break the N≡N triple bond and overcome the sluggish kinetics, the reactor operates at a high temperature (400-450° C.). The downside of this high temperature is its negative effect on the thermodynamic equilibrium of the exothermal reaction. To shift the reaction equilibrium back to the NH₃ side, the pressure of the reacting gases is increased to 150-250 bar using a multistage steam compressor, prior to injection into the reactor.

In the Ostwald process, ammonia is catalytically oxidized to produce concentrated nitric acid (50-65 w/w %). At low temperatures (150-200° C.), N₂ is the only product. When the temperature is increased, selectivity towards N₂O increases, and passes through a maximum around 400° C. Upon further increase in temperature, the selectivity towards NO, which is the desired product, increases continuously. In practice, temperatures of 600-900° C. are. The downside of these extreme temperatures is the limited lifetime of the Pt-Rh catalyst, which needs to be replaced every 3-12 months. The Ostwald process is responsible for emission of N₂O by-product, which is a potent greenhouse gas. Despite great efforts to reduce N₂O emissions, even the best performing plants still emit significant amounts of N₂O.

Both Haber-Bosch and Ostwald processes require extreme reaction conditions (high pressure and temperature), which comes with safety risks. Furthermore, both anhydrous ammonia and concentrated nitric acid are highly corrosive substances, requiring more expensive materials. Ammonium nitrate is currently obtained by acid-base reaction of ammonia with nitric acid and is by itself not corrosive, but unreacted traces of HNO₃ and NH₃ remain present and cause corrosion issues. Moreover, in the solid form, ammonium nitrate also creates an explosion risk.

As currently applied techniques require a very large scale (>100 000 ton/year), there is a need in the art for alternatives for decentralized ammonia production powered by renewable energy sources, such as green electricity. The possibility to produce ammonia through electrochemical reduction of N₂ gas has been explored and widely reported, but the observed selectivity is low and yields remain orders of magnitude below what is required for industrial application.

Plasma-enabled direct ammonia synthesis from N₂ and H₂ is a possibility, but the yields are low and energy consumption considerable (>15 MJ/mol NH₃) and can only produce ammonia, not ammonium nitrate. Plasma nitrogen oxidation and catalytic reduction to ammonia (PNOCRA process) which combines plasma-assisted nitrogen oxidation and lean NOx trap technology is a more efficient alternative. It achieves an energy requirement of 4.6 MJ mol⁻¹ NH₃, which is more than four times less than the state-of-the-art (Hollevoet, L et al Angew. Chem. Int. Ed. 2020, 59, 23825-23829). This PNOCRA process yields ammonia, but also allows the possibility to produce ammonium nitrate by reacting NOₓ from the plasma reactor with water, producing a solution of HNO₃, which can be combined with the produced ammonia. However, this approach has the risk of forming explosive mixtures of H₂ and O₂ and is highly complex, requiring the switching of phases, a large number of components (multiple absorption columns, expensive Lean NOx Trap catalysts, etc.). Furthermore, this approach consumes a large amount of hydrogen (>4 mol H₂ per mol NH₃ produced).

Finally, the possibility to use a plasma reactor for generating nitrites or nitrates, and electrochemical reduction to ammonia has been proposed (Sun, J. et al. Energy Eviron. Sci. 2021, 14, 865-872 and patents CN110983356 or WO202177730_A1). However, this approach involves inserting a plasma bubbler and an electrolyser in a single volume, and operating the production in a batch-wise manner, making it impractical, hard to scale and difficult to tune process parameters. Furthermore, this approach requires a separate source of large amounts of pure oxygen or oxygen-enriched air and would result in the emission of large amounts of harmful gaseous chemicals such as NH₃, NO, NO₂, N₂O etc. Finally, this approach has only been proposed as a way to produce ammonia, not ammonium nitrate.

Thus, there is a need in the art for a scalable, practical, safe and efficient continuous process to produce ammonium nitrate from a N₂ and O₂ comprising gas, for instance air, and water, without emission of other harmful gasses (NH₃, NO, NO₂, N₂O etc.). Present invention provides such process and apparatus to carry out the process.

### SUMMARY OF THE INVENTION

The process of this invention combining plasma-assisted nitrogen oxidation, NOx adsorption and electrochemical nitrite and/or nitrate reduction is particularly suitable for small-scale green ammonium nitrate production with production yields of 10-1000 ton NH₄NO₃ per year. It has a very low intrinsic greenhouse gas footprint (<0.1 ton CO₂ equivalents per ton NH₄NO₃) and runs on air, water and (renewable) electricity. It is a new, energy-efficient route towards plasma-driven ammonium nitrate synthesis involving plasma oxidation of N₂ to produce NOₓ, followed by NOₓ absorption by water in an absorption step, forming an aqueous solution containing HNO₃ and HNO₂, and electrochemical reduction of nearly all nitrite (NO₂⁻) and part of the nitrate (NO₃⁻) to ammonium (NH₄⁺), which in combination with residual nitrate yields a solution of ammonium nitrate (NH₄NO₃) with a NH₄NO₃ concentration at least above 10 w/w % and preferably above 50 w/w %. The energy cost of such process is estimated to be below 9 MJ/mol NH₄NO₃, which is significantly better than for the previously reported plasma-based NH₃ production, directly from N₂ and H₂. This process is attractive especially for small and medium-scale decentralized ammonium nitrate synthesis (10-1000 ton NH₄NO₃ annually), and offers unique opportunities for decentralized production of ammonium nitrate fertilizers. Furthermore, corrosion risks are reduced due to a lower concentration of HNO₃ (<10 w/w %), compared to the industrial Ostwald process (50-65 w/w %). Explosion risk is also avoided by eliminating the presence of solid ammonium nitrate.

In accordance with the purpose of the invention, as embodied and broadly described herein, the invention is broadly drawn to a process for the ammonium nitrate production from a N₂ and O₂ comprising gas and water, whereby a N₂ and O₂ comprising gas feedstock is fed into at least one plasma reactor, Consequently, a gas reaction output from the at least one plasma reactor [A] is fed into at least one absorption column [B], and additionally water is fed into at least one absorption column [B]. Further, the aqueous output from the at least one absorption column [B] is fed into at least one electrolyser [C]. The O₂ gas reaction output from the at least one electrolyser [C] is fed into the at least one plasma reactor [A] and the gas output (for instance O₂ and N₂) from the at least one absorption column [B] is fed into the at least one plasma reactor [A].

Another aspect of the invention is an apparatus for the ammonium nitrate production from a N₂ and O₂ and water, the apparatus comprising at least one pump for pumping fluids and further comprising at least one plasma reactor [A], at least one absorption column [B], at least one electrolyser [C]. In the apparatus, at least one plasma reactor is connected by a fluid guidance with at least one absorption column [B] for feeding plasma reactor gas reaction output into at least one absorption column [B]. At least one absorption column [B] is foreseen with fluid guidance for feeding water therein, and at least one absorption column [B] is functionally connected by fluid guidance with at least one electrolyser [C] for feeding aqueous output for at least one absorption column [B] is fed into at least one electrolyser [C]. At least one electrolyser [C] is functionally connected with a fluid guidance to at least one plasma reactor [A] in order to feed O₂ gas reaction output from at least one electrolyser [C] into at least one plasma reactor [A]. At least one absorption column [B] is functionally connected by fluid guidance with at least one plasma reactor [A] to feed the gas output (comprising O₂ and N₂) from at least one absorption column [B] into at least one plasma reactor [A]. The apparatus further comprising fluid guidance functionally connect with the at least one absorption column [B] for feeding water into the at least absorption column [B].

Some embodiments of the invention are set forth in claim format directly below:
1) A process for the ammonium nitrate production from a N₂ and O₂ comprising gas and water, characterised in that
   1. N₂ and O₂ comprising gas feedstock is fed into at least one plasma reactor [A],
   2. gas reaction output from the at least one plasma reactor [A] is fed into at least one absorption column [B] and additionally water is fed into the at least one absorption column [B],
   3. the aqueous output from at least one absorption column [B] is fed into at least one electrolyser [C],
   4) O₂ gas reaction output from the at least one electrolyser [C] is fed into the at least one plasma reactor [A],
   5) gas output (for instance O₂ and N₂) from the at least one absorption column [B] is fed into the at least one plasma reactor [A].
2) The process according to embodiment 1, whereby the aqueous output from the at least one electrolyser [C] is fed back into the at least one absorption column [B].
3) The process according to any one of the embodiments 1 and 2, whereby gas output, from the at least one absorption column [B], is fed through at least one oxidation chamber [D] and the reaction output thereof is fed into the at least one absorption column [B].
4) The process according to any one of the embodiments 1 and 3, whereby the N₂ and O₂ comprising gas feedstock is fed into at least one plasma reactor [A] by pumping through a connecting gas guidance
5) The process according to any one of the embodiments 1 and 4, whereby the N₂ and O₂ in the at least one plasma reactor [A] is reacted into NO₂ and NO
6) The process according to any one of the embodiments 1 and 5, whereby the N₂ and O₂ in the at least one plasma reactor [A] is reacted into NO₂ and NO according to the equations N₂+2 O_{2→2} NO₂ and N₂+O₂→2 NO.
7) The process according to any one of the embodiments 1 and 6, whereby the gas pumping is by a compressor [E].
8) The process according to any one of the embodiments 1 and 7, whereby the gas reaction output from the at least one plasma reactor [A] comprising O₂, N₂ and NOₓ is fed into at least one absorption column [B] and additionally water is fed into the at least one absorption column [B] for the reaction of NO₂ with H₂O, according to the equations 2 NO+O₂→2 NO₂ and 3 NO₂+H₂O→2 HNO₃+NO.
9) The process according to any one of the embodiments 1 and 8, whereby the aqueous output of the at least one absorption column [B] comprising aqueous HNO₃ and aqueous NH₄NO₃ is fed into an at least one electrolyser [C] for further reacting.
10) The process according to any one of the embodiments 1 and 9, whereby the aqueous output of the at least one absorption column [B] comprising aqueous HNO₃ and aqueous NH₄NO₃ is fed into at least one electrolyser [C] for further reacting according to the equations: Cathode: NO₃⁻+10 H⁺+8 e⁻→3 H₂O+NH₄⁺ and Anode: 2 H₂O→4 e⁻+4 H⁺+O₂, which combined result in the overall equation NO₃⁻+2 H⁺+H₂O→NH₄⁺+2 O₂.
11) The process according to any one of the embodiments 1 and 10, whereby aqueous HNO₃ and/or aqueous NH₄NO₃ output from the at least one electrolyser [C] is fed back into the at least one absorption column [B].
12) The process according to any one of the embodiments 1 and 11, whereby gas output comprising NO. from the at least one absorption column [B], is fed through at least one oxidation chamber [D] for reacting NO and O₂ into 2 NO₂ according to the equation NO+O₂→2 NO₂ and the reaction output thereof is fed into the at least one absorption column [B].
13) The process according to any one of the embodiments 1 and 12, whereby more than 90% of the nitrites and 40-50% of the nitrates entering the at least one electrolyser [C] are converted into ammonium ions so that at the outlet of the at least one electrolyser a solution with an NH₄NO₃/HNO₃ ratio above 10 is released.

Each of the a above embodiments also describe an aspect of the invention or further embodiment of the invention when “comprising” is replaced by the more closed terms “consisting essentially of” or “consisting of” and when “at least one” is replaced by “a” and when “the at least one” is replaced by “the”.

Some other aspects of the invention are set forth in claim format directly below:
1) A device for the ammonium nitrate production from a N₂ and O₂ comprising gas and water comprising of
   1) at least one plasma reactor [A] connected with at least one gas input guidance (for receiving a N₂ and O₂ comprising gas feedstock) connected with at least one gas guidance output (for releasing reaction gas),
   2) at least one absorption column [B] connected to the at least one gas reaction output guidance from the at least one plasma reactor [A], whereby the at least one absorption column [B] is also connected to at least one water guidance input (to feed additionally water into the at least one absorption column [B]) and whereby the at least one absorption column [B] is also further connected to at least one aqueous reaction liquid output guidance (to release reaction liquid),
   3) at least one electrolyser [C] connected with the at least one aqueous reaction liquid output guidance of the least one absorption column [B] and the at least one electrolyser [C] connected with at least one O₂ gas reaction output guidance with at least one plasma reactor [A] (to feed O₂ gas reaction into the at least one plasma reactor [A])
   5) gas output (for instance O₂ and N₂) from the at least one absorption column [B] is fed into the at least one plasma reactor [A].
2) The device according to statement 1, whereby the at least one electrolyser [C] is further connected with at least one aqueous output guidance with the at least one absorption column [B] (to feed aqueous output back into the at least one absorption column [B]).
3) The device according to any one of the statements 1 and 2, whereby at least one gas output, from the at least one absorption column [B], is connected to at least one oxidation chamber [D] and the at least one oxidation chamber [D] is connected with at least one reaction output liquid guidance with the at least one absorption column [B].
4) The device according to any one of the statements 1 and 3, further comprising at least one liquid pump and at least one gas pump, for instance at least one compressor [E].

Yet some aspects of the invention are set forth in claim format directly below:
1) A process for the ammonium nitrate production from a N₂ and O₂ comprising, consisting of or essentially consisting of gas and water, characterised in that
   1) gas feedstock comprising, consisting of or essentially consisting of N₂ and O₂ is fed into a plasma reactor [A],
   2) gas reaction output from the plasma reactor [A] is fed into a absorption column [B] and additionally water is fed into the absorption column [B],
   3) the aqueous output from the absorption column [B] is fed into an a electrolyser [C],
   4) O₂ gas reaction output from the electrolyser [C] is fed into the plasma reactor [A],
   5) gas output (for instance O₂ and N₂) from the absorption column [B] is fed into the plasma reactor [A].
2) The process according to statement 1, whereby the aqueous output from the electrolyser [C] is fed back into the absorption column [B].
3) The process according to any one of the statements 1 and 2, whereby gas output, from the absorption column [B], is fed through a oxidation chamber [D] and the reaction output thereof is fed into the a absorption column [B].
4) The process according to any one of the statements 1 and 3, whereby the gas feedstock comprising, consisting of or essentially consisting of N₂ and O₂ is fed into a plasma reactor [A] by pumping (for instance by a compressor) through the connecting gas guidance.
5) The process according to any one of the statements 1 and 4, whereby the N₂ and O₂ in the plasma reactor [A] is reacted into NO₂ and NO.
6) The process according to any one of the statements 1 and 5, whereby the N₂ and O₂ in the plasma reactor [A] is reacted into NO₂ and NO according to the equations N₂+2 O₂→2 NO₂ and N₂+O₂→2 NO.
7) The process according to any one of the statements 1 and 6, whereby the gas reaction output from the plasma reactor [A] comprising, consisting of or essentially consisting of O₂, N₂ and NOₓ is fed into a absorption column [B] and additionally water is fed into the absorption column [B] for the reaction of NO₂ with H₂O according to the equations 3 NO₂+H₂O→2 HNO₃+NO and 2 NO+O₂→2 NO₂.
8) The process according to any one of the statements 1 and 7, whereby the aqueous output of the absorption column [B] comprising, consisting of or essentially consisting of aqueous HNO₃ and aqueous NH₄NO₃ is fed into an electrolyser [C] for further reacting.
9) The process according to any one of the statements 1 and 8, whereby the aqueous output of the absorption column [B] comprising, consisting of or essentially consisting of aqueous HNO₃ and aqueous NH₄NO₃ is fed into a electrolyser [C] for further reacting according to the equation: Cathode: NO₃⁻+10 H⁺+8 e⁻→3 H₂O+NH₄⁺ and Anode: 2 H₂O→4 e⁻+4 H⁺+O₂, which combined result in the overall equation NO₃⁻+2 H⁺+H₂O→NH₄⁺+2 O₂.
10) The process according to any one of the claims 1 and 9, whereby aqueous HNO₃ and/or aqueous NH₄NO₃ output from the electrolyser [C] is fed back into the absorption column [B].

11) The process according to any one of the claims 1 and 10, whereby gas output comprising, consisting of or essentially consisting of NO. from the absorption column [B], is fed through a oxidation chamber [D] for reacting NO and O₂ into NO₂ according to the equation NO+O₂→2 NO₂ and the reaction output thereof is fed into the a absorption column [B].

12) The process according to any one of the embodiments 1 and 11, whereby more than 90% of the nitrites and 40-50% of the nitrates entering the electrolyser [C] are converted into ammonium ions so that at the outlet of the electrolyser a solution with an NH₄NO₃/HNO₃ ratio above 10 is released.

Each of the a above statements also describe an aspect of the invention or further embodiment of the invention when “comprising” is replaced by the more closed terms “consisting essentially of” or “consisting of” and when “at least one” is replaced by “a” and when “the at least one” is replaced by “the”.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. It is to be understood that both the foregoing general description and the following detailed description are exemplary and explanatory only, and are not restrictive of the invention, as claimed.

### DETAILED DESCRIPTION

### Detailed Description of Embodiments of the Invention

The following detailed description of the invention refers to the accompanying drawings. The same reference numbers in different drawings identify the same or similar elements. In addition, the following detailed description does not limit the invention. Instead, the scope of the invention is defined by the appended claims and equivalents thereof.

A liquid pump in this application means a pump for pumping a liquid fluid and a gas pump means a pump for pumping a gas fluid.

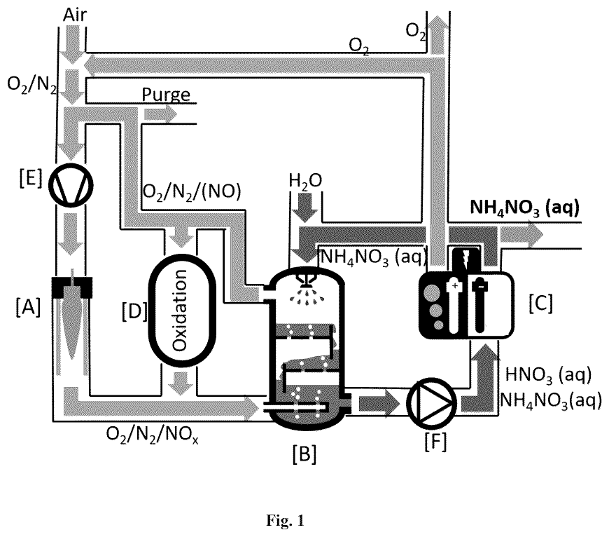

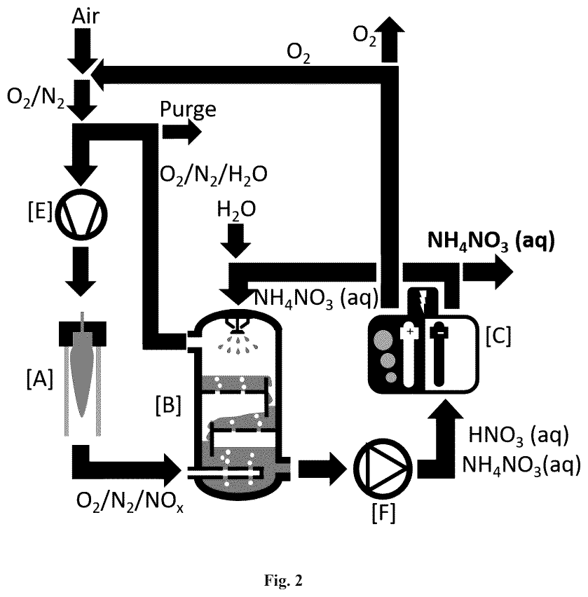

Referring now specifically to the drawings, a Plasma reactor according to an embodiment of the present invention is illustrated in FIG. 1 and FIG. 2 and shown generally as reference letter [A].

An absorption column according to an embodiment of the present invention is illustrated in FIG. 1 or FIG. 2 and shown generally as a reference letter [B]. The absorption column [B] has particular application in the process or is a particular reactor in the device of present invention where gas is brought into contact with liquid, and one or more of the components present in the gas phase react with and/or are dissolved in the liquid phase. Different designs are possible, with one or more equilibrium stages, for example in a column with trays or in a column packed with solid particles to enhance contact between the gas and liquid phase.

An electrolyser according to an embodiment of the present invention is illustrated in FIG. 1 or FIG. 2 and shown generally as reference letter [C]. The electrolyser [C] has particular application in imaging a unit operation where an electrical potential is applied between one or more pairs of electrodes. Each pair of electrodes is separated by a membrane.

An oxidation tank according to an embodiment of the present invention is illustrated in FIG. 1 or FIG. 2 and shown generally as reference letter [D]. The oxidation tank [D] has particular application in imaging a unit operation where gas coming from the absorption column [C] is stored in the tank for a period of time, to allow NO present in the gas phase to be converted into NO₂, which can be absorbed more easily in the absorption column.

A compressor according to an embodiment of the present invention is illustrated in FIG. 1 or FIG. 2 and shown generally as reference letter [E]. The compressor [E] has particular application in imaging a unit operation where gas is compressed to overcome backpressure of the plasma reactor [A], the absorption column [B] and the piping and to ensure a steady gas flow.

A liquid pump according to an embodiment of the present invention is illustrated in FIG. 1 or FIG. 2 and shown generally as reference letter [F]. The liquid pump [F] has particular application in imaging a unit operation that invokes a pressure increase in the aqueous solution, in order to overcome backpressure of the electrolyser [C], absorption column [B] and piping, and to ensure a steady liquid flow.

It will be apparent to those skilled in the art that various modifications and variations can be made in aspect of the separate unit using the integration or design of the present invention and in construction of the system and method without departing from the scope or spirit of the invention. Examples of such modifications have been previously provided.

Ammonia is one of the most important globally produced chemicals. It is an essential fertilizer in agriculture and a crucial building block in chemical and pharmaceutical industries. It also emerges as an alternative carbonless renewable fuel. The industrial production of ammonia via the Haber-Bosch process amounts to ca. 150 million tons annually. The Haber-Bosch process operated with natural gas results in ca. 1.7 kg CO₂ production per 1 kg of NH₃. Therefore, greener, more sustainable routes towards ammonia production are actively investigated. The use of “green”, “blue” or “turquoise” hydrogen in the Haber-Bosch process is an option. Alternatively, electrification of ammonia synthesis can be achieved with electrocatalysis, or with plasma technology.

Plasma is an ionized gas, which consists of electrons, ions, neutral gas molecules, excited molecular species, radicals and atoms, and photons. The vast interest in plasma is due to its unique properties. Plasma generates highly reactive species, which facilitate N₂ fixation, can be operated under atmospheric pressure, and can be powered with renewable electricity, which makes it perfectly suited for decentralized and intermittent production. In plasma catalysis, a catalyst is introduced in the plasma reactor to kinetically enhance the desired reaction.

The synthesis of NH₃ from N₂ and H₂ is thermodynamically favoured. However, due to sluggish kinetics, large amounts of energy are currently required to activate the chemically inert N₂ molecule. Plasma overcomes this problem, because the applied electric energy mainly heats up the light electrons, which activate the N₂ molecules by electron impact dissociation, ionization and excitation, creating atoms, ions and excited species, which easily react into other compounds, such as NH₃. However, the current state-of-the-art of plasma-catalytic NH₃ synthesis clearly indicates that it suffers from a major drawback: an apparent compromise between either low energy consumption or a large concentration of ammonia in the reaction product. Nevertheless, this is not a physical law, but rather the situation in the current state-of-the art. More fundamental research, both experimental and computational, is needed to overcome the current limitations.

NH₃ concentrations in excess of 10% are accompanied by high energy consumptions exceeding 80 MJ mol⁻¹ NH₃. A plasma process with a relatively low energy consumption of 2 MJ mol⁻¹ NH₃, being close to that of the Haber-Bosch process, (0.52-0.81 MJ mol⁻¹) yields a very diluted NH₃ product (<0.1 vol %). The recovery of NH₃ from such a diluted product mixture would be very challenging and highly energy intensive. The lowest reported energy cost with a reasonable yield (1.4%) is 18.6 MJ mol⁻¹ NH₃ (K. Aihara, et al., Chem. Commun. 2016, 52, 13560-13563)

A low ammonia concentration in the reactor outlet can dramatically increase the overall energy consumption of the ammonia synthesis process. The high energy demand of plasma-driven NH₃ synthesis in its current state calls for an alternative approach.

This application proposes plasma nitrogen oxidation, absorption in water and electrochemical reduction to ammonium nitrate, which combines plasma, NOx absorption in water and electrochemistry to overcome the inefficiency of plasma processes for ammonia synthesis. Plasma is suited very well for oxidation reactions, rather than chemical reduction. Therefore, in the proposed process, N₂ is first oxidized to NOx. These NOx react with water to form an aqueous solution containing HNO₂ and HNO₃. Almost all HNO₂ (90-100%) and around half of HNO₃ (40-50%) is reduced to ammonia and/or ammonium by means of electrochemistry. This results in an aqueous solution containing ammonium nitrate with the molar ratio of NH₄NO₃/HNO₃ above 10.

The current BAT (best available technology) for plasma-catalytic NH₃ synthesis from H₂ and N₂ has an energy cost of 18.6 MJ mol⁻¹ NH₃ and a yield of 1.4% (K. Aihara, et al., Chem. Commun. 2016, 52, 13560-13563). Adding the energy consumption of reactants production (0.51 MJ mol⁻¹ NH₃) and product separation (0.54 MJ mol⁻¹ NH₃) results in a total energy consumption of 19.65 MJ mol⁻¹ NH₃ (A. Anastasopoulou, et al., J. Ind. Ecol. 2020, 24, 1-15).

The Haber-Bosch process is only cost-efficient at a very large scale. Most Haber-Bosch plants produce 300 000 to 600 000 ton/year, with some even up to 1 000 000 ton/year (C. Philibert, Renewable Energy for Industry: From Green Energy to Green Materials and Fuels, 2017). Ammonia is a precursor for the industrial ammonium nitrate production, and thus the same large scale is required for ammonium nitrate production by combination of the Haber-Bosch and Ostwald processes. Plasma nitrogen oxidation, absorption in water and electrochemical reduction to ammonium nitrate is scalable and very well suited for a decentralized small to medium scale ammonium nitrate production (10-1000 ton/year), for example, close to farms, eliminating transport costs for fertilizers.

The process or device of present invention advantageously comprises that a nitrogen oxidation plasma reactor can operate at feed gas flow rates of 10 L min⁻¹ and that the absorption column and electrolyser can be scaled to virtually any size. Plasma nitrogen oxidation and catalytic reduction to ammonia or ammonium which combines plasma-assisted nitrogen and lean NOx trap technology therefore enables decentralized NH₄NO₃ production starting at a scale ranging from 10-1000 ton/year.

Because the plasma nitrogen oxidation, absorption in water and electrochemical reduction to ammonium nitrate employs both nitrogen oxidation to NOₓ and reduction to ammonia or ammonium, it is particularly well suited for decentralized ammonium nitrate fertilizer production. While around 80% of the globally produced NH3 is used for the production of N- fertilizers, only 3% is used directly as fertilizer. One of the most common fertilizers is ammonium nitrate (NH₄NO₃), accounting for 43% of N-fertilizers.

Plasma nitrogen oxidation, absorption in water and electrochemical reduction to ammonium nitrate is a disruptive alternative technology to the fossil-fuel based Haber-Bosch process, and its implementation would go along with industrial and market transformation. Currently, one technology cannot be disruptive enough. Thus, for centralized ammonia production the integration of a combination of innovative concepts, each with their own strengths and weaknesses is required to complement electrified Haber-Bosch processes. Plasma nitrogen oxidation, absorption in water and electrochemical reduction to ammonium nitrate is one of these new pieces of the CO₂-neutrality puzzle.

As schematically visualized in FIGS. 1 and 2, present invention comprises ammonium nitrate production from a N₂ and O₂ comprising gas feedstock ((ambient) air)) whereby 1) the gas feedstock [E]) guided into at least one plasma reactor [A] whereby N₂ and O₂ are reacted into NO₂ and NO (according to the equations N₂+2 O₂→2 NO₂ and N₂+O₂→2 NO), 2) the gas reaction output (comprising O₂, N₂ and NOₓ) of the at least one plasma reactor [A] and water is guided into at least one absorption column [B] for the reaction 3 NO₂+H₂O→2 HNO₃+NO and 2 NO+O₂→2 NO₂ (side reactions may take place as well, main side reactions are NO+NO₂+H₂O→2 HNO₂ and 2 NO₂+H₂O→HNO₂+HNO₃), 3) the aqueous output (aqueous HNO₃ and/or aqueous NH₄NO₃) is guided into at least one electrolyser [C] where these are reacted, for instance according to the equations: Cathode: NO₃⁻+10 H₊+8 e⁻→3 H₂O +NH₄⁺ and Anode: 2 H₂O→4 e⁻+4 H⁺+O₂, which combined result in the overall equation NO₃⁻+2 H⁺+H₂O→NH₄⁺+2 O₂4) O₂ gas reaction output is from the at least one electrolyser [C] guided into the plasma reactor [A]; 5) gas output, for instance O₂ and N₂. from the at least one absorption column [B] is guided into the at least one plasma reactor [A] 6) optionally the aqueous output (aqueous HNO₃ and/or aqueous NH₄NO₃) from the at least one electrolyser [C] is guided back into the at least one absorption column [B], 6) optionally gas output, for instance comprising NO. from the at least one absorption column [B], is guided through at least one oxidation chamber [D] for reacting 2 NO+O₂→2 NO₂ and guiding the reaction output into the at least one absorption column [B].

An advantageous aspect of the apparatus and method of present invention, described above, is that the direct combination of NH₃ and HNO₃ in aqueous solution avoids highly corrosive products and explosion risks. In addition, much lower temperatures and pressures can be used compared to industrial processes of the art. Another advantage is that no noble metal catalysts are needed. Furthermore, the O₂ output from the electrolyser(s) allows closed process loop, meaning no gasses are emitted by the process, when this is not purged. Air has a 21/78 ratio of O₂/N₂ gasses. If air would be used as such with a closed process loop, the share of oxygen would be too low for N₂ oxidation in a closed loop, and N₂ gas would accumulate. However, in the present invention, a solution is found in using the electrolyser [C] as an additional source of O₂. This way, the gas phase loop (including the plasma reactor [A], the absorption column [B], the compressor [E] and optionally the oxidation chamber [D]) can be closed (except for a small purge to avoid accumulation of inert gasses such as Ar).

The amount of oxygen produced by the electrolyser is dependent on the Faradaic efficiency of the electrolyser [C] for the reduction of NO₃⁻ and NO₂⁻ to NH₃. If the combined Faradaic efficiency for nitrite and nitrate reduction is below 85%, O₂ from electrolyser [C] and air are sufficient to operate with a closed gas phase loop. If the combined Faradaic efficiency of nitrite and nitrate reduction is above 85%, some additional O₂ is required to enable a closed gas phase loop, and can be supplied by replacing the air feed with oxygen enriched air (30-50% O₂), or adding another supply of pure oxygen. The closed gas phase loop strongly reduces emission of harmful by-products (N₂O, NOₓ, NH₃, . . . ) into the atmosphere. The process allows obtaining high concentrations of ammonium nitrate (>10 w/w %, preferably even >50 w/w %) while avoiding high HNO₃ concentrations (<10 w/w %) due to recirculation.

Under the circumstances described above, the process loop is closed (except for purge). This eliminates almost all harmful gaseous emissions, such as NOx, N₂O, NH₃ etc. Furthermore, using the oxygen produced by the electrolyser enables high oxygen concentrations in the gas stream fed to the plasma reactor, which boosts the plasma reactor performance.

An additional feature of the process is the possibility to produce high concentrations of ammonium nitrate (>10 w/w %, preferably >50 w/w %) without the need for highly concentrated nitric acid (<10 w/w %) or an additional product separation step, by recirculating the majority of the product (>50%) coming from the electrolyser [C].

This would not be achieved by simply placing the existing components after each other.

An optional approach is to separate all the ammonium nitrate out of the stream coming from the electrolyser. However, this requires an additional energy consuming separation step.

In one embodiment, the process for ammonium nitrate production, as illustrated in FIG. 2, combines three main unit operations: a plasma process producing NOx, a NOx absorption column and an electrolyser. Furthermore, the process is equipped with one or more pumps, compressors and flow regulators.

In a first step, the plasma reactor partly converts a mixture of N₂ and O₂ into NOₓ (NO and/or NO₂), generating a gaseous mixture of O₂, N₂ and NOₓ, according to Eq. 1-2.

N₂+O₂→2 NO (Eq. 1)

N₂+2 O₂→2 NO₂ (Eq. 2)

In the next step, the gaseous mixture is sent to a NOₓ absorption column, where NOₓ and O₂ are brought into contact with water to form an aqueous solution with HNO₃, according to Eq. 3-4. HNO₂ can also be formed as an intermediate reaction product. The water fed to the absorption column also contains dissolved ammonium nitrate, and possibly some unreacted HNO₃.

4 NO+3 O₂+2 H₂O→4 HNO₃ (Eq. 3)

4 NO₂+O₂+2 H₂O→4 HNO₃ (Eq. 4)

The gas stream exiting the absorption column, comprised mainly of N₂ and O₂, is recycled back to the plasma reactor. A small share of the gas can be purged to avoid build-up of inert gasses like Ar.

The aqueous stream exiting the absorption column contains dissolved NH₄NO₃ and HNO₃. Some HNO₂ by-product can be present as well.

This aqueous stream is sent to an electrochemical reactor, where HNO₃ is reduced electrochemically to ammonia through the Nitrate Reduction Reaction at the cathode of the electrochemical cell (Eq. 5). The HNO₂ by-product is also converted to ammonia, according to the Nitrite Reduction Reaction (Eq. 6). The Oxygen Evolution reaction (Eq. 7) is the preferred reaction at the counter electrode, resulting in the global cell reactions given by Eq. 8-9.

Cathode: HNO₃+8 H⁺+8 e⁻→NH₃+3 H₂O (Eq. 5)

Cathode: HNO₂+6 H⁺+6 e⁻→NH₃+2 H₂O (Eq. 6)

Anode: 2 H₂O→4 H⁺+O₂+4 e⁻ (Eq. 7)

Cell: HNO₃+H₂O→NH₃+2 O₂ (Eq. 8)

Cell: 2 HNO₂+2 H₂O→2 NH₃+3 O₂ (Eq. 9)

The liquid stream exiting the electrochemical reactor is an aqueous solution of dissolved NH₄NO₃ and possibly some unreacted HNO₃, with an NH₄NO₃/HNO₃ ratio of at least 10. This stream can be partly recirculated and partly withdrawn from the process loop as final product. By recirculating the majority of the aqueous stream to the washing column, a high concentration of NH₄NO₃ can be achieved.

In another aspect, the present invention provides, the aqueous stream exiting the electrochemical reactor can be refrigerated, resulting in the precipitation of solid NH₄NO₃ salt product. The aqueous stream is then recirculated to the washing column.

Because of the combination of high temperature and pressure and a complex process scheme with a large number of unit operations (compressors, heat exchangers, condenser, off gas purification, catalyst loaded reactors, etc.), most existing ammonium plants produce volumes in the range of 300 to 600 kton/y (Philibert C. Renewable Energy for Industry: From green energy to green materials and fuels. International Energy Agency. 2017). The process of present invention is based on modular technology such as plasma reactors and electrolysers and can be economically viable at small and medium scale (10-1,000 ton/year).

Combining the Haber-Bosch process for ammonia production and the Ostwald process for nitric acid production from ammonia is the current industrial route for ammonium nitrate production from ammonia and nitric acid. One of the disadvantages of the Electrified Haber-Bosch+Ostwald route is the need for a relatively large amount of hydrogen (3 mol H₂/mol NH₄NO₃ required), which is the main contributor to the operational cost of the process. Only 1.5 mol H₂/mol NH₃ is required, but ammonium nitrate production via this route requires two moles of NH₃, one of which is oxidized in the Ostwald process. The process of present invention, on the contrary, does not require any hydrogen supply.

By using the O₂ produced at the anode of the electrochemical cell, the feedstock gas (air) going to the plasma reactor is enriched with oxygen. The ratio of produced oxygen to ammonium nitrate produced depends on the Faradaic efficiency of the electrochemical cell towards ammonia. If the Faradaic efficiency is below 85%, sufficient oxygen is produced and the process only requires water, electricity and air. If the Faradaic efficiency is above 85%, the process requires water, electricity and enriched air (O₂ concentration of 30-50%) or an additional O₂ supply.

The use of O₂ from the electrochemical cell (possibly in combination with oxygen-enriched air or an additional oxygen supply, depending on Faradaic efficiency) makes it possible to tune the O₂/N₂ ratio in the plasma reactor, which has been shown to lower the energy cost and increase NOₓ concentration. Furthermore, it allows closing the gas phase process loop, which includes the plasma reactor and the absorption column. This way, harmful components (e.g., NO, NO₂, N₂O) will decompose in the plasma reactor and emission to the atmosphere can be greatly decreased or even eliminated.

The share of intermittent energy sources such as solar and wind in the electricity supply is expected to increase further. The ability of highly energy-consuming processes, such as the production of ammonium nitrate, to cope with fluctuations in energy supply is therefore crucial. The electrified Haber-Bosch process can handle energy supply fluctuations by adapting the rate of H₂ production in the electrolyser, and including a H₂ buffer capacity, but the H-B reactor and the subsequent Ostwald process each require steady-state operation and a steady feed of H₂. Furthermore, wind and solar energy are decentralized in nature, while the Haber-Bosch and Ostwald processes are highly centralized. Therefore, a smaller-scale process is more fit to be supplied with renewable energy.

In the process of present invention, the plasma reactors [A] are responsible for the main share of the energy consumption. A large plasma unit can consist of several small plasma reactors in parallel. These individual reactors can be switched on/off rapidly to follow a variable energy supply. Besides the plasma reactors [A], the electrolyser [C] is also responsible for a share of the energy consumption, and its operation can also be adapted to the energy supply. Hence, the process of present invention can adapt to fluctuations in energy supply.

Operating the process below full capacity also requires a low CAPEX. Several characteristics of the process of the present invention suggest a low installation cost. By the immediate combination of nitrate and ammonium ions in the aqueous phase, the presence of corrosive substances such as anhydrous ammonia and highly concentrated HNO₃ are avoided. Furthermore, ammonium nitrate formation process operates at nearly atmospheric pressure and temperatures below 50° C. These factors enable the use of inexpensive materials. In addition, the process does not make use of expensive noble metal catalysts. Electrocatalysts for nitrate reduction can be made e.g., out of copper.

Furthermore, renewable energy sources are characterised by a decentralized nature, which requires processes that can be economically viable at a medium and small scale. Due to the very high pressures and temperatures, the Haber-Bosch and Ostwald processes are dependent on economy of scale. The process of present invention is run at milder temperature and pressure, and with less corrosive fluids. The plasma unit, the electrochemical reactor and the NOx absorption column are modular in nature. This can make smaller production facilities economically viable.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### DRAWING DESCRIPTION

### Brief Description of the Drawings

The present invention will become more fully understood from the detailed description given herein below and the accompanying drawings which are given by way of illustration only, and thus are not limitative of the present invention, and wherein:

FIG. 1 is a schematic view showing ammonium nitrate production from a N₂ and O₂ comprising gas feedstock ((ambient) air) whereby 1) the gas feedstock (by a pump [E]) guided into at least one plasma reactor [A] whereby N₂ and O₂ is reacted into NO₂ and NO (according to the equations N₂+2 O₂→2 NO₂ and N₂+O₂→2 NO), 2) the gas reaction output (comprising O₂, N₂ and NOₓ) of the at least one plasma reactor [A] and water is guided into (at least one) an absorption column [B] for the reaction 3 NO₂+H₂O→2 HNO₃+NO and 2 NO+O₂→2 NO₂, 3) the aqueous output (aqueous NHO₃ and/or aqueous NH₄NO₃) is guided into an at least one electrolyser [C] where these are reacted, for instance according to the equations Cathode: NO₃⁻+10 H⁺+8 e⁻→3 H₂O+NH₄⁺ and Anode: 2 H₂O→4 e⁻+4 H⁺+O₂, which combined result in the overall equation NO₃⁻+2 H⁺+H₂O→NH₄⁺+2 O₂, 4) O₂ gas reaction output is from the at least one electrolyser [C] is guided into the at least one plasma reactor [A]; 4) gas output, for instance O₂ and N₂. from at least one absorption column [B] is guided into at least one plasma reactor [A]; 5) optionally the aqueous output (aqueous HNO₃ and/or aqueous NH₄NO₃) from the at least one electrolyser [C] is guided back into the at least one absorption column [B]; 6) optionally gas output, for instance comprising NO, from at least one absorption column [B], is guided through at least one oxidation chamber [D] for the reaction 2 NO+O₂→2 NO₂, and the reaction output is guided into the at least one absorption column [B].

FIG. 2 is a schematic view illustrating yet another specific embodiment of a process of present invention, it shows a plasma reactor [A], a NOx absorption column [B], an electrolyser [C], a gas pump or a compressor [E] and a liquid pump [F] and the functional connections between these reaction units.

1.-12. (canceled)

13. A process for the ammonium nitrate production from a N₂ and O₂ comprising gas and water, wherein
1) N₂ and 02 comprising gas feedstock is fed into at least one plasma reactor [A],
2) gas reaction output from the at least one plasma reactor [A] is fed into at least one absorption column [B] and additionally water is fed into the at least absorption column [B],
3) the aqueous output for the at least one absorption column [B] is fed into an at least one electrolyser [C],
4) O₂ gas reaction output from the at least one electrolyser [C] is fed into the at least one plasma reactor [A],
5) gas output (for instance O2 and N2) from the at least one absorption column [B] is fed into the at least one plasma reactor [A].

14. The process according to claim 13, wherein the aqueous output from the at least one electrolyser [C] is fed back into the at least one absorption column [B].

15. The process according to claim 13, wherein gas output, from the at least one absorption column [B], is fed through at least one oxidation chamber [D] and the reaction output thereof is fed into the at least one at least one absorption column [B].

16. The process according to claim 13, wherein the N2 and O2 comprising gas feedstock is fed into at least one plasma reactor [A] by pumping (for instance by a compressor) through the connecting gas guidance.

17. The process according to claim 13, wherein the N2 and O2 in the at least one plasma reactor [A] is reacted into NO2 and NO.

18. The process according to claim 13, wherein the N₂ and O2 in the at least one plasma reactor [A] is reacted into NO2 and NO according to the equations N2+2 O2→2 NO2 and N2+O2→2 NO.

19. The process according to claim 13, wherein the gas reaction output from the at least one plasma reactor [A] comprising O2, N2 and NOx is fed into at least one absorption column [B] and additionally water is fed into the at least one absorption column [B] for the reaction of NO2 with H2O according to the equations 3 NO2+H2O→2 HNO3+NO and 2 NO+O2→2 NO2.

20. The process according to claim 13, wherein the aqueous output of the at least one at least one absorption column [B] comprising aqueous HNO3 and aqueous NH4NO3 is fed into at least one electrolyser [C] for further reacting.

21. The process according to claim 13, wherein the aqueous output of the at least one absorption column [B] comprising aqueous HNO3 and aqueous NH4NO3 is fed into at least one electrolyser [C] for further reacting according to the equation: Cathode: NO3−+10 H++8 e−→3 H2O+NH4+ and Anode: 2 H2O→4 e−+4 H++O2, which combined result in the overall equation NO3−+2 H++H2O→NH4++2 O2.

22. The process according to claim 13, wherein aqueous HNO3 and/or aqueous NH4NO3 output from the at least one electrolyser [C] is fed back into the at least one absorption column [B].

23. The process according to claim 13, wherein gas output comprising NO, from the at least one absorption column [B], is fed through at least one oxidation chamber [D] for reacting NO and O2 into NO2 according to the equation NO+O2→2 NO2 and the reaction output thereof is fed into the at least one at least one absorption column [B].

24. The process according to claim 13, wherein more than 90% of the nitrites and 40-50% of the nitrates entering the at least one electrolyser [C] are converted into ammonium ions so that at the outlet of the at least one electrolyser a solution with an NH4NO3/HNO3 ratio above 10 is released.
